(19) United States
(12) Patent Application Publication
(10) Pub. No.: US 2025/0279099 A1
(43) Pub. Date: Sep. 4, 2025

(54) PERSONAL AGENT USING VISION TRANSFORMER

(71) Applicant: GOOGLE LLC, Mountain View, CA (US)

(72) Inventor: Dongeek Shin, San Jose, CA (US)

(21) Appl. No.: 18/592,066

(22) Filed: Feb. 29, 2024

(51) Int. Cl. G10L 15/25; G10L 15/08

(52) U.S. Cl. CPC G10L 15/25; G10L 15/08

(57) ABSTRACT

Implementations utilize an ultrasound signal emitted by a locally installed speaker to collect reflections of the ultrasound signal that are associated with a mouth motion of a user that delivers an unvoiced utterance. In various implementations, pulse compression and/or waterfall reconstruction are performed on the collected reflections of the ultrasound signal, to generate a sequence of time-aligned waterfall image chunks. The sequence of time-aligned waterfall image chunks can be processed using a fine-tuned vision transformer that is connected to a classifier or a text decoder, to classify or determine utterance content of the unvoiced utterance. A corresponding assistant action can then be determined and performed based on the determined utterance content of the unvoiced utterance.

### BACKGROUND

Humans can engage in human-to-computer dialogs with interactive software applications referred to herein as “personal agents” (or “personal assistants,” “intelligent agent” “chatbots,” “voice assistants,” “conversational agents,” “automated assistant”, etc.). A personal agent can often be invoked and/or controlled via voice interfaces (e.g., using voice command(s)). For example, the personal agent can receive and process an audio signal capturing a spoken utterance (e.g., “Assistant, turn on the TV”) which is received via a voice interface of a microphone, to recognize natural language content (e.g., “Assistant, turn on the TV” in natural language) of the spoken utterance. Based on the recognized natural language content of the spoken utterance, the personal agent determines user intent (e.g., turn on <device>) and/or parameters (e.g., “TV”) associated with the user intent. From the user intent and/or the associated parameters, an assistant action (e.g., cause the TV to be turned on) can be determined and performed, in response to the spoken utterance.

While speech/voice interaction via the voice interfaces (e.g., of microphone(s)) requires no visual attention and can be applied in scenarios where the environment is dark or where remote control is desired, applications of the voice interfaces are restricted in various other scenarios where spoken utterances (e.g., loud speech) are discouraged or simply not possible. For example, speaking in public areas (e.g., library) can oftentimes be annoying to nearby people and bear the risk of disclosing personal or sensitive information to unknowns. As another example, accuracy of speech recognition declines in noisy environments, which affects the invocation or control of the personal agent. As a further example, speech recognition (or interaction) using acoustic signals can be inapplicable to people with speaking or hearing difficulties.

### SUMMARY

Implementations disclosed herein relate to providing an ultrasound lip/mouth reading framework for voice interaction. In various implementations, the ultrasound lip reading framework utilizes ultrasound signals (which are non-invasive and inaudible) to perform recognition (e.g., transcription or classification) for utterance content of voiced or unvoiced utterance(s). Such ultrasound-based speech recognition and interaction can supplement or replace voice interactions realized through spoken utterance(s) and can extend application of a personal agent that incorporates the ultrasound lip reading framework to scenarios where spoken utterances are discouraged or difficult to perform using automatic speech recognition (ASR). Further, ultrasound signals are known to be non-invasive and inaudible, which minimizes the risk of disturbing the environment, etc. The ultrasound signals can also be conveniently transmitted by speaker(s) that are embedded in products or devices such as a laptop. This reduces manufacturing cost to develop needed hardware components (e.g., customized cameras for capturing images of a mouth motion) to perform lip reading through other approaches.

In various implementations, a client device having a microphone and a speaker is utilized to perform, using an ultrasound approach, lip reading of a user near the client device (e.g., about or less than 20-30 cm away from the client device), although this is not meant to be limiting. The microphone and the speaker can both be on-board of the client device (e.g., locally embedded/installed at the client device), although this is not required in all instances. The speaker of the client device can be utilized to actively emit/transmit an ultrasound signal. In some implementations, the ultrasound (or “ultrasonic”) signal may take the form of a Tukey-tapered, linear chirp that linearly spans/varies a frequency from approximately 21 kHz to 22 kHz. In some implementations, the linear chirp is repeated at a chirp repetition rate of approximately 20 Hz. The microphone of the client device can be utilized to receive reflections (e.g., multi-path reflections in the form of an ultrasound wave) of the ultrasound signal that are reflected from the user that performs a mouth motion (e.g., lip articulation, which is to provide an unvoiced utterance) while the mouth motion is being performed. Such reflections of the ultrasound signal are associated with the mouth motion that delivers the voiced or unvoiced utterance (e.g., a silent utterance/speech of “press play” without the user actually uttering a voice), and thus is considered to capture the mouth motion which formulates the voiced or unvoiced utterance.

In various implementations, utterance content (may also be referred to as “word content”, which for instance can be “press play”) of the voiced or unvoiced utterance can be determined/recognized (via transcription or classification) based on the aforementioned reflections of the ultrasound signal, using a fine-tuned transformer-based machine learning (ML) model. In some implementations, the reflections of the ultrasound signal can be processed to generate a sequence of time-aligned waterfall image chunks. For instance, pulse compression can be performed on the reflections of the ultrasound signal, to generate a compressed ultrasound waveform (may also be referred to as “pulsed compressed ultrasound signal”). The compressed ultrasound waveform, for instance, can have an improved signal-to-noise ratio (SNR) with respect to the reflections of the ultrasound signal. In some implementations, waterfall reconstruction can be performed on the compressed ultrasound waveform to generate a waterfall image showing a plurality of waterfall features which are associated with the mouth motion that delivers the utterance. The waterfall image can be linearly divided into the sequence of time-aligned waterfall image chunks.

In various implementations, the sequence of time-aligned waterfall image chunks can be processed as input, e.g., using the fine-tuned transformer-based ML model, to generate a model output from which the utterance content of the unvoiced utterance is derived. In some implementations, based on the utterance content of the unvoiced utterance, a personal agent (may also be referred to as “voice assistant”) can be invoked or controlled in response to the unvoiced utterance of the user. For instance, given the unvoiced utterance of “press play”, the personal agent can perform an assistant action that causes a “play” button displayed at a user interface of the client device (or another device) to be selected, so that a video (or audio or other media content) can be played.

By detecting voiced or unvoiced utterance(s) using ultrasound signals and analyzing reflections of the ultrasound signals that are associated with the utterance(s) using a transformed-based machine learning model, lip reading can be performed and utterance content of the voiced or unvoiced utterance(s) can be classified or determined. In some implementations, based on the utterance content including a user command directed to a smart device (or an application), a control signal can be generated (e.g., via the voice assistant) to control the smart device (or an API call for the smart device or application can be executed) in response to the user command. In some implementations, based on the utterance content of the utterance(s) including a user query, a natural language response responsive to the user query can be determined and rendered (e.g., visually and/or audibly) to a user that provides the user query.

The silent voice interface(s) (e.g., of microphone(s)) that detect unvoiced utterances using reflections of ultrasonic signal(s) can supplement spoken voice interactions enabled by speech recognition of acoustic signals. This way, utterance content of silent utterances (or extremely low-voice utterances) can be recognized, without a user actually uttering a voice. This extends applications of a voice assistant into scenarios where applications of the traditional voice interfaces are restricted (e.g., noisy environment) and/or where spoken utterances (e.g., loud speech) are discouraged (e.g., speaking in public areas such as libraries and/or talking about personal identifiable information) or impossible (e.g., speaking difficulties).

Various implementations provide a method implemented using one or more processors. The method includes: receiving, via a client device, reflections (of an ultrasound signal) that capture a mouth motion of a user over a time interval. In some implementations, a silent utterance (may also be referred to as “unvoiced utterance” or “silent speech”) is delivered via the mouth motion of the user of the client device. Put another way, the mouth motion of the user formulates the silent utterance. In some implementations, the client device includes a speaker to emit the ultrasound signal and a microphone to receive the reflections. In some implementations, the ultrasound signal includes a Tukey-tapered, linear chirp (e.g., a coded signal) that linearly spans/varies a frequency from approximately 21 kHz to 22 kHz, where the linear chirp is repeated at a chirp repetition rate of approximately 20 Hz.

In some implementations, the speaker and the microphone are included locally at the client device, and the user is within a predetermined distance (e.g., 20 cm, or 30 cm, etc.) from the client device.

In various implementations, the method further includes processing the received reflections (of the ultrasound signal) that capture the mouth motion of the user, to generate a sequence of time-aligned waterfall image chunks. As a non-limiting example, the sequence of time-aligned waterfall image chunks can include a first waterfall image chunk that corresponds to reflections of the ultrasound signal during a first time period (e.g., t1˜t2), a second waterfall image chunk that corresponds to reflections of the ultrasound signal during a second time period (e.g., t2˜t3) immediately following the first time period (e.g., t1˜t2), and . . . , an Nth waterfall image chunk that corresponds to reflections of the ultrasound signal during an Nth time period (e.g., tn-1˜tn, where n is a positive integer equal to or greater than 1). In some implementations, optionally, a length of the first time period (e.g., t2-t1) can be approximately the same as a length of other time period (e.g., the second, third, . . . , or the Nth time period).

In some implementations, processing the received reflections of the ultrasound signal that capture the mouth motion of the user, to generate the sequence of time-aligned waterfall image chunks can include: performing pulse compression on the reflections of the ultrasound signal, to acquire a compressed ultrasound waveform (may also be referred to as “pulse compressed reflections”, or “a pulse compressed ultrasound signal”, etc.); performing waterfall reconstruction (which will be described with reference to FIG. 1F) on the compressed ultrasound waveform to generate a waterfall image (e.g., as a heatmap); and linearly dividing the waterfall image to generate the sequence of time-aligned waterfall image chunks.

In various implementations, the method further includes processing the sequence of waterfall image chunks, using a transformer-based machine learning model, to generate a model output that recognizes word content of the silent utterance.

In some implementations, the transformer-based ML model includes a pre-trained linear mapper (e.g., 1911 in FIG. 1B) that linearly embeds the sequence of time-aligned waterfall image chunks, to generate a sequence of input embeddings. For instance, each image chunk (e.g., represented in the form of a vector), in the sequence of time-aligned waterfall image chunks, can be processed using the pre-trained linear mapper (e.g., by multiplying with an embedding matrix), to generate a corresponding input embedding (which can have a reduced dimension with respect to the vector that represents a corresponding image chunk). In this case, the generated input embeddings form the sequence of input embeddings, to be processed using a pre-trained transformer encoder of the transformer-based ML model. It is noted that a position embedding can be generated to record (or reflect) a time sequence for the image chunks in the sequence of time-aligned waterfall image chunks.

In some implementations, the transformer-based ML model includes a pre-trained transformer encoder having one or more encoder blocks stacked/applied in a sequence, where each encoder block can include a layer of multi-head self-attention mechanism and a layer of feed-forward network. The sequence of input embeddings and the position embedding can be processed as input, using the pre-trained transformer encoder, to learn long-range dependencies between the time-aligned waterfall image chunks. For instance, an encoder output (e.g., a sequence of embeddings representing image features extracted from the sequence of time-aligned waterfall image chunks) can be generated using the pre-trained transformer encoder, based on processing of the sequence of input embeddings and the position embedding.

In some implementations, the transformer-based ML model includes a fine-tuned classifier (which can include a single layer of a fully connected neural network) to classify the silent utterance. For instance, the encoder output of the transformer encoder can be processed as input using the fine-tuned classifier, to generate probabilities each indicating a likelihood that the word content of the silent utterance (which is delivered by the mouth motion that is captured in the aforementioned reflections of the ultrasound signal) corresponds to one of a plurality of predefined labels (e.g., a first label of “Okay, Assistant”, a second label of “press play”, and a third label of “null”). Based on the generated probabilities, the word content of the silent utterance can be classified. As a non-limiting example, if the generated probabilities include a first probability of approximately 0.75 predicted for the first label of “Okay, Assistant”, a second probability of approximately 0.2 predicted for the second label of “press play”, and a third probability of approximately 0.05 predicted for the third label of “null”, the word content of the silent utterance can be classified as “Okay, Assistant”. In this example, the model output of the transformer-based machine learning model can be, for instance, “the word content of the silent utterance is classified as: Okay, Assistant”.

In some implementations, the transformer-based machine learning model can include a text decoder to transcribe the aforementioned sequence of embeddings (sometimes referred to as “image embeddings”) generated using the pre-trained transformer encoder into the word content (may also be referred to as “utterance content”) of the silent utterance.

In some implementations, a frequency of the ultrasound signal (emitted by the speaker of the client device) can be modified based on a transcription rate of the image embeddings into the word content of the silent utterance. The ultrasound signal, for instance, can have a frequency range of approximately 21-22 kHz. For example, the ultrasound signal can be a Tukey-tapered, linear chirp that linearly spans/varies a frequency from approximately 21 kHz to 22 kHz, where the linear chirp is repeated at a chirp repetition rate of approximately 20 Hz. In some implementations, the chirp repetition rate (“repetition rate”) can be modified based on a transcription rate of the image embeddings which are transcribed into the word content of the silent utterance. In some implementations, the chirp repetition rate can be modified based on a rate of the mouth motion.

In some implementations, the transformer-based ML model can be pre-trained based on a large set of training data (e.g., labeled images) and/or be fine-tuned using a plurality of training instances. It is noted that, during fine-tuning, parameters of the pre-trained linear projector and transformer encoder can remain “frozen” (i.e., unchanged), while parameters of the classifier (i.e., the final fully connected neural network) can be fine-tuned/modified. The plurality of training instances can include, for instance, a first set of training instances. Each training instance from the first set can include a waterfall image constructed based on ultrasound reflections, which are from a user that uses a mouth motion to deliver a first silent utterance (e.g., “Okay, Assistant”), for an ultrasound signal emitted by a speaker of a computing device, as training instance input. The same training instance can include training instance output derived from the first silent utterance (e.g., “Okay, Assistant”). For instance, the same training instance can include a ground truth label of the first silent utterance (e.g., “Okay, Assistant”) as the training instance output.

Additionally or alternatively, the plurality of training instances can include, for instance, a second set of training instances. Each training instance from the second set can include a waterfall image constructed based on ultrasound reflections, which are from a user that uses a mouth motion to deliver a second silent utterance (e.g., “Press play”), for an ultrasound signal emitted by a speaker of a computing device, as training instance input. The same training instance can include training instance output derived from the second silent utterance (e.g., “Press play”). For instance, the same training instance can include a ground truth label of the second silent utterance (e.g., “Press play”) as the training instance output.

Optionally, different training instances from the first set (or other set, if there is any) can respectively include a waterfall image constructed based on ultrasound reflections received from different users. For instance, a first training instance from the first set can include a waterfall image constructed based on ultrasound reflections received from a first user, and a second training instance from the first set can include a waterfall image constructed based on ultrasound reflections received from a second user (different from the first user).

Optionally, different training instances from the first set (or other set, if there is any) can respectively include a waterfall image constructed based on ultrasound reflections of an ultrasound signal emitted by a distinct client device. For instance, a first training instance from the first set can include a waterfall image constructed based on ultrasound reflections of a first ultrasound signal emitted by a first computing device (e.g., a laptop), and a second training instance from the first set can include a waterfall image constructed based on ultrasound reflections of a second ultrasound signal emitted by a second computing device (e.g., another laptop, or another type of computing device different from the first computing device, such as a cellphone, etc.). The first ultrasound signal can be the same as or different from the second ultrasound signal.

Additionally or alternatively, the plurality of training instances can include, for instance, a third set of training instance. Each training instance from the third set can include a waterfall image constructed based on ultrasound reflections, which are from a user when the user has no mouth motion (and as a result, no utterance, be it silent utterance or spoken utterance), for an ultrasound signal emitted by a speaker of a computing device, as training instance input. The same training instance can include a ground truth label of “null” (or “no utterance”, etc.) as the training instance output.

In various implementations, the method further includes causing a voice assistant to be invoked or to perform an assistant action based on the recognized word content of the silent utterance.

In some implementations, causing the voice assistant to be invoked or to perform the assistant action based on the recognized word content of the silent utterance can include: causing the voice assistant to be invoked based on the recognized word content of the silent utterance including a hotword that invokes the voice assistant. The hotword can be configured by a developer (or service provider) of the voice assistant, and for instance, can be “Okay, Assistant” or “Assistant”, etc.

In some implementations, causing the voice assistant to be invoked or to perform the assistant action based on the recognized word content of the silent utterance can include: causing the voice assistant to perform the assistant action based on the recognized word content of the silent utterance including one or more words that identify the assistant action.

In some implementations, the voice assistant can be invoked or controlled using an audible utterance (“voiced utterance”), in addition to being invoked/controlled using unvoiced utterance(s). For instance, the voice assistant can be invoked in response to a spoken speech of “Hey Assistant”, based on a speech recognition of the utterance content of the spoken speech indicating that the utterance content of the spoken speech includes hotword(s) (e.g., “Hey Assistant”) that launches the voice assistant.

The preceding is presented as an overview of only some implementations disclosed herein. These and other implementations are disclosed in additional detail herein. For example, additional and/or alternative implementations are disclosed herein such as those realizing lip reading via a camera which captures images showing the mouth motion of the user, where utterance content of the unvoiced utterance can be estimated from the captured images (in addition to or in replacement of the sequence of time-aligned image chunks linearly divided from a waterfall image that is constructed from reflections of an ultrasound signal that capture a mouth motion of a user that delivers a silent utterance).

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example scenario where a transformer-based machine learning model is utilized in understanding an unvoiced utterance, in accordance with various implementations disclosed herein.

FIG. 1C illustrates another example scenario where a transformer-based machine learning model is utilized in understanding an unvoiced utterance, in accordance with various implementations disclosed herein.

FIG. 1D illustrates pre-training of a transformer-based machine learning model using a large set of images, in accordance with various implementations disclosed herein.

FIG. 1E illustrates fine-tuning of the transformer-based machine learning model in FIG. 1D using additional images each generated based on reflections of an ultrasound signal that capture a mouth motion associated with an unvoiced utterance, in accordance with various implementations disclosed herein.

FIG. 1F illustrates an example method of generating a waterfall image based on reflections of an ultrasound signal, in accordance with various implementations disclosed herein.

FIG. 2A depicts an example of a waterfall image showing waterfall features for an unvoiced utterance, in accordance with various aspects of the present disclosure.

FIG. 2B depicts an example of a waterfall image showing waterfall features for another unvoiced utterance, in accordance with various aspects of the present disclosure.

FIG. 3 depicts a flowchart illustrating an example method of recognizing an unvoiced utterance using a trained transformer-based machine learning model, in accordance with various aspects of the present disclosure.

FIG. 4A depicts a flowchart illustrating an example method of generating a training instance to train a transformer-based machine learning model, in accordance with various aspects of the present disclosure.

FIG. 4B depicts a flowchart illustrating fine-tuning of a transformer-based machine learning model, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It's appreciated that different features from different embodiments may be combined with and/or exchanged for one another. In addition, those of ordinary skill in the art will recognize that various changes and modifications of the various embodiments described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

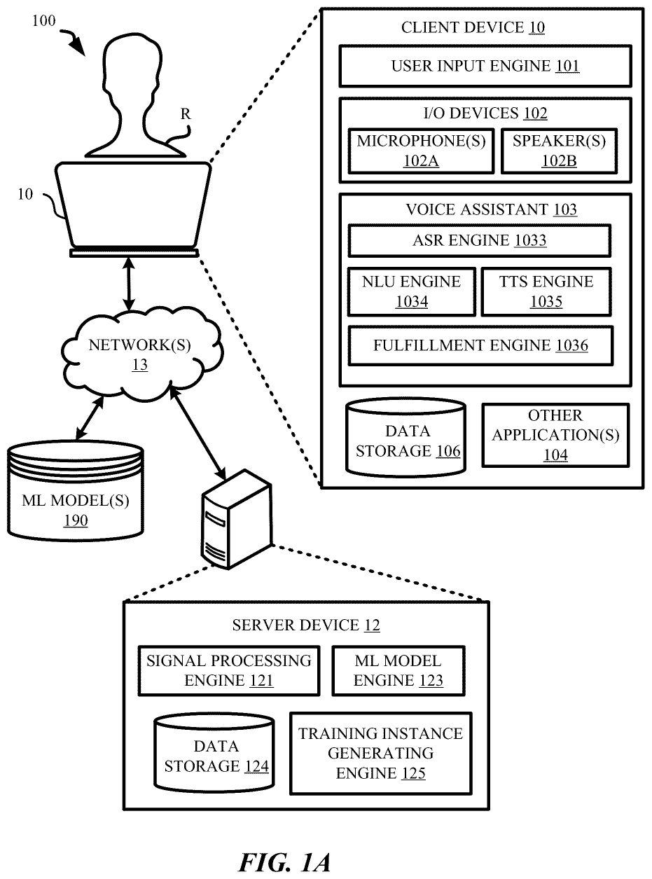

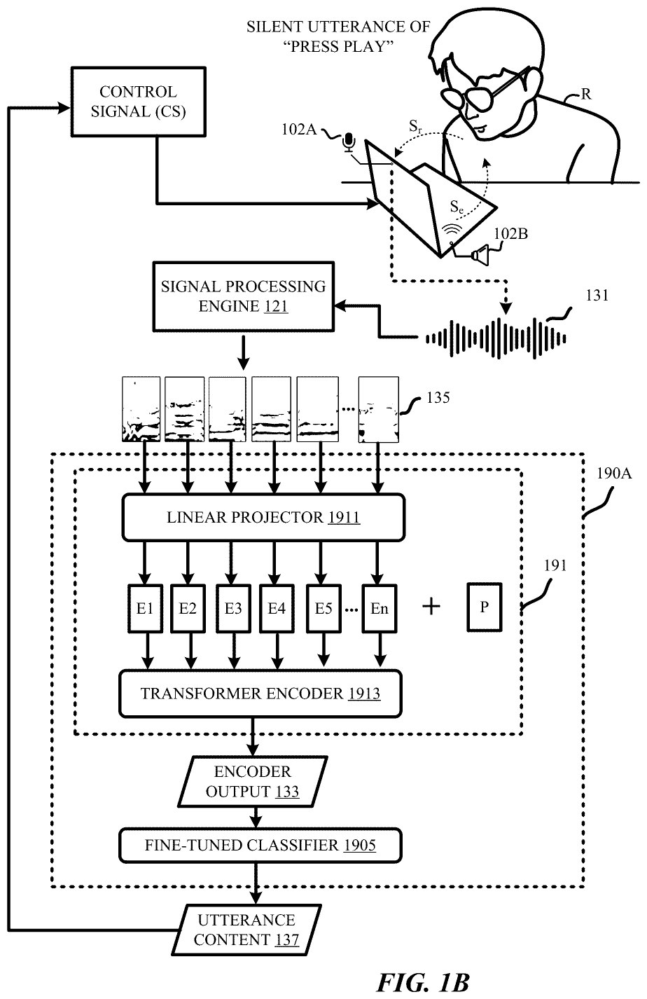

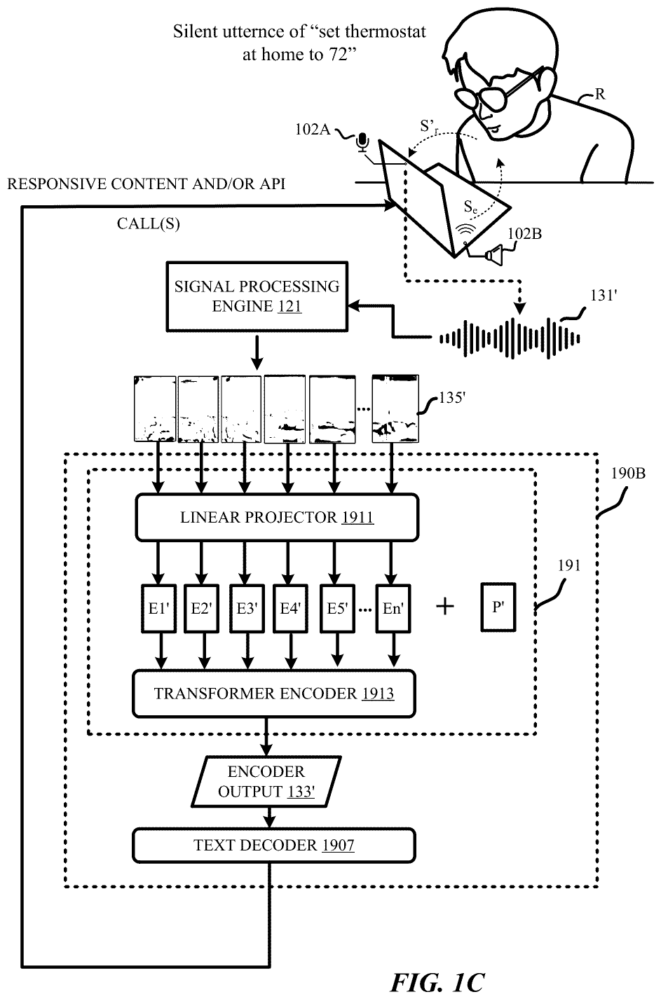

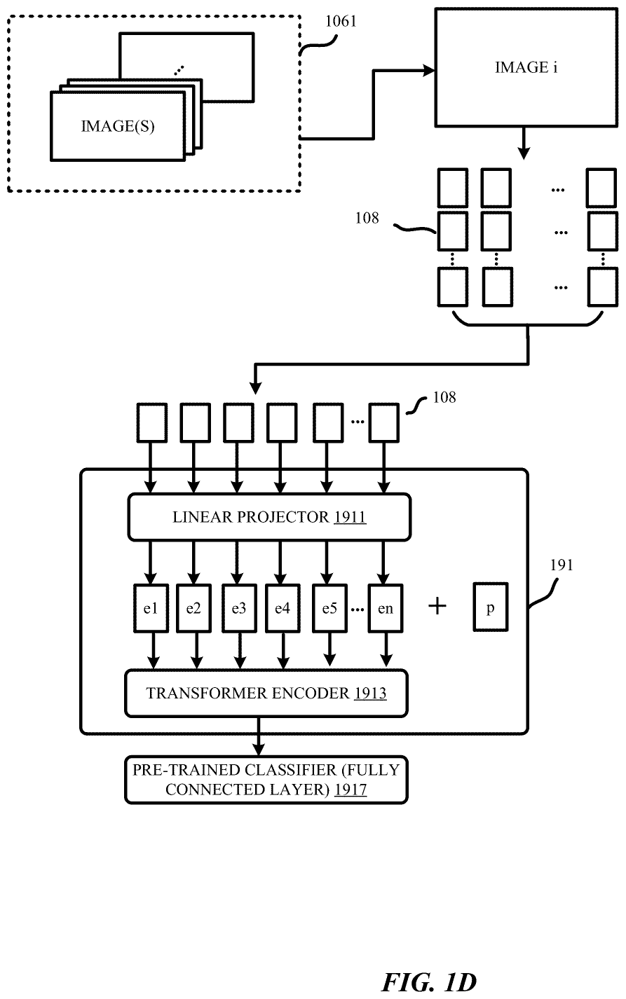

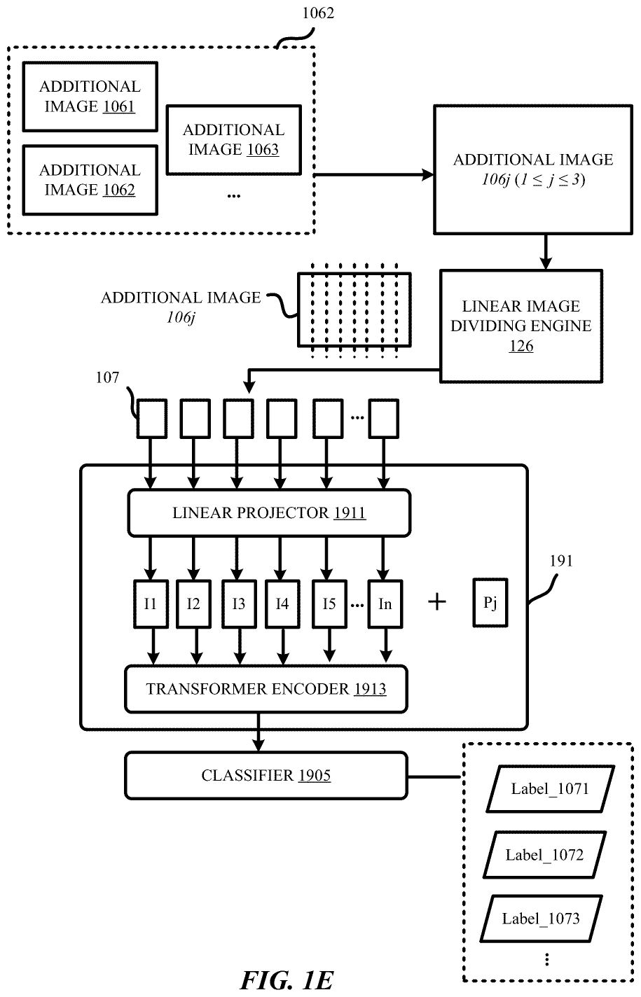

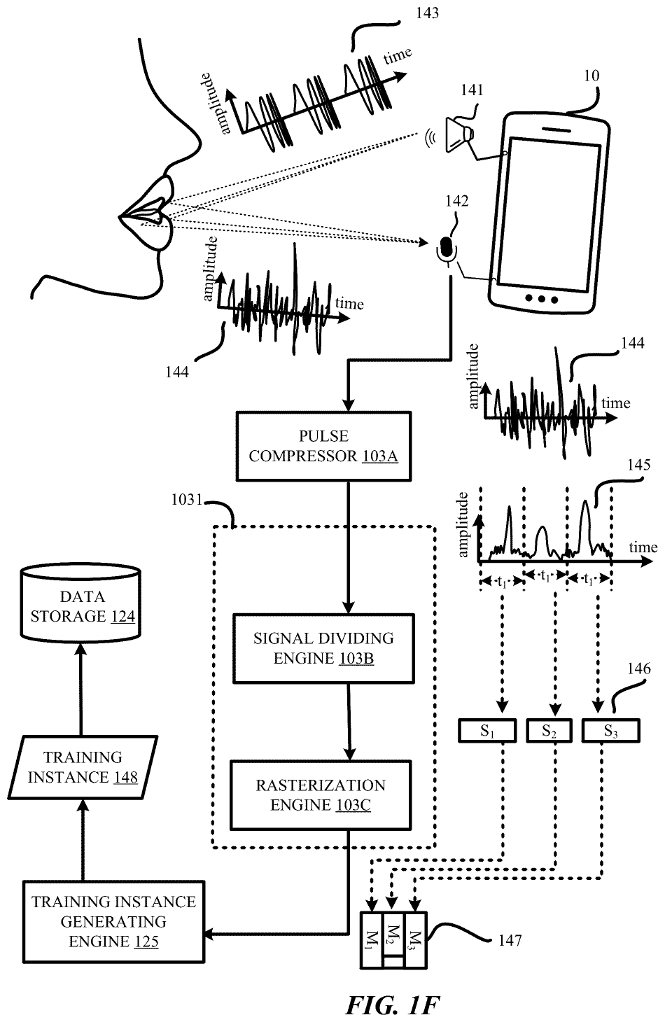

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) in communication with the client computing device 10. The server computing device 12 can communicate with the client computing device 10 via one or more networks 13. The one or more networks 13 can include, for example, a local area network (LAN), a wide area network (WAN) such as the Internet, and/or any other appropriate network.

The client computing device 10 can be, for example, a desktop computing device, a laptop computing device, a tablet computing device, a mobile phone computing device, a computing device of a vehicle (e.g., an in-vehicle entertainment or navigation system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

In various implementations, the client computing device 10 can include software component(s) such as a user input engine 101 and/or hardware component(s) such as input and output (I/O) device(s) 102. The I/O device(s) 102 can include, for instance, one or more speakers 102B and one or more microphones 102A. The one or more speakers 102B can emit an ultrasound signal (e.g., a Tukey-tapered, linear chirp that linearly spans/varies a frequency from approximately 21 kHz to 22 kHz, the linear chirp being repeated at a chirp repetition rate of approximately 20 Hz). The ultrasound signal can be reflected by different portions (e.g., lip, tongue, etc.) of a mouth of a user that is within a predetermined distance of the client computing device 1, forming multi-path reflections (see, for example, in FIG. 1F) that are received by the one or more microphones 102A.

In some implementations, the I/O device(s) 102 can include other hardware component(s) such as a display (not depicted) to visually render natural language content and/or visual content, and/or a keyboard (not depicted) to receive typed input, touch input, or other types of input. The user input engine 101 can be configured to detect user input provided by a user of the client computing device 10 using one or more input devices. For example, the aforementioned keyboard can receive typed input. As another example, the client computing device 10 can be equipped with a mouse (or one or more hardware buttons) to receive a user click that selects one or more graphical user interface (GUI) elements that is rendered visually at a user interface of the client computing device 10. Additionally, or alternatively, the one or more microphones 102A can capture audio data, such as audio data corresponding to spoken utterances of the user or other sounds in an environment of the client computing device 10. Additionally, or alternatively, the client computing device 10 can be equipped with one or more vision components (e.g., a camera) that are configured to capture vision data corresponding to images and/or movements (e.g., mouth motion, gestures, etc.) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input directed to the client computing device 10.

In various implementations, the client computing device 10 can further include one or more applications. The one or more applications can include, for instance, a voice assistant 103 and other application(s) 104. The voice assistant 103 can include or otherwise access, for instance, a signal processing engine 121. Put another way, the signal processing engine 121 can be included in the server computing device 12, or included in the client computing device 10, or be included in both. The signal processing engine 121 can, for instance, process the multi-path reflections of the aforementioned ultrasound signal that are received by the one or more microphones 102A. The multi-path reflections of the ultrasound signal can be processed to generate a sequence of time-aligned waterfall image chunks, to be fed into a fine-tuned transformer-based machine learning (ML) model such as 190. The sequence of time-aligned waterfall image chunks can be associated with a mouth motion of the user to deliver a voiced or unvoiced utterance (e.g., a silent speech directed to the voice assistant 103).

In some implementations, the voice assistant 103 can further include, or otherwise access, a ML model engine 123. Put another way, the ML model engine 123 can be included in the server computing device 12, or included in the client computing device 10, or be included in both. The ML model engine 123 can process the sequence of time-aligned waterfall image chunks using the fine-tuned transformer-based ML model 190, to recognize utterance content of the unvoiced utterance. In some implementations, the recognized utterance content can include hotword(s) to invoke the voice assistant 103. In this case, in response to receiving the multi-path reflections of the ultrasound signal and in response to determining that the recognized utterance content of the unvoiced utterance includes hotword(s) (e.g., “Okay, Assistant”, “Assistant”, “Hey Assistant”, etc.) to invoke the voice assistant 103, the voice assistant 103 can be invoked.

In some implementations, the recognized utterance content can include a user command (e.g., “press play”) to interact with a selectable element (e.g., a “play” button) rendered via an application of the client computing device 10. In this case, in response to receiving the multi-path reflections (of the ultrasound signal) that are associated with the mouth motion of the user to deliver the unvoiced utterance and in response to determining that the recognized utterance content includes the user command to interact with (e.g., “press”) the rendered selectable element (e.g., the “play” button), the rendered selectable element can be selected/visually pressed (e.g., via the voice assistant 103).

In some implementations, the recognized utterance content can include a user command to control a smart device in communication with the client computing device 10. In this case, in response to receiving the multi-path reflections (of the ultrasound signal) that are associated with the mouth motion of the user to deliver the unvoiced utterance and in response to determining that the recognized utterance content includes the user command to control the smart device (e.g., set room temperature of 70 degree for a thermostat), the smart device (e.g., thermostat) can be controlled (e.g., via the voice assistant 103, to set the room temperature to be approximately 70 degrees).

In some implementations, the recognized utterance content can include a user query for responsive content. In this case, in response to receiving the multi-path reflections (of the ultrasound signal) that are associated with the mouth motion of the user to deliver the unvoiced utterance and in response to determining that the recognized utterance content includes the user query for responsive content, a search based on the user query (or generation of the responsive content based on the user query using a generative model) can be performed, for instance, using the voice assistant 103.

In some implementations, the voice assistant 103 can, but does not necessarily need to, include a natural language understanding (NLU) engine 1034, and/or a fulfillment engine 1036. In some implementations, the voice assistant 103 can, but does not necessarily need to, an ASR engine 1033. The ASR engine 1033 can process audio data that captures a spoken utterance (e.g., “press pause”) to generate a speech recognition of the spoken utterance.

The NLU engine 1034 can determine semantic meaning(s) of a text and/or the audio (e.g., the aforementioned audio data capturing the spoken utterance). The NLU engine 1034 can decompose the determined semantic meaning(s) to determine intent(s) and/or parameter(s) for an assistant action (performable via the voice assistant 103). For instance, the NLU engine 1034 can process natural language content of “Press pause”, to determine a NLU intent of “press a button” and/or parameters (e.g., “pause” button) for an assistant action of selecting/pressing the “pause” button. It is noted that, by including or otherwise communicating with the signal processing engine 121 and the ML model engine 123, the voice assistant 103 can determine utterance content of unvoiced utterance(s) in natural language, and perform an assistant action based on the determined utterance content of unvoiced utterance(s). Such silent voice interaction may supplement or replace spoken utterance interactions, e.g., in situations (e.g., library or noisy environment) where spoken utterance is discouraged, impossible, or hard to recognize.

In some implementations, the NLU engine 1034 can resolve the intent(s) and/or parameter(s) based on a single utterance of a user and, in other situations, prompts can be generated based on unresolved intent(s) and/or parameter(s). In this latter situation, the generated prompts can be rendered (e.g., visually and/or audibly) to the user to receive user response(s), where the user response(s) to the rendered prompt(s) can be utilized by the NLU engine 1034 in resolving intent(s) and/or parameter(s). Optionally, the NLU engine 1034 can work in concert with a dialog manager engine (not illustrated) that determines unresolved intent(s) and/or parameter(s). For instance, the dialog manager engine can be alternatively or additionally utilized to generate the aforementioned prompt(s). In some implementations, the NLU engine 1034 can utilize one or more NLU machine learning models in determining intent(s) and/or parameter(s).

In some implementations, the fulfillment engine 1036 of the voice assistant can receive an intent and/or parameter(s) of the intent, to fulfill the intent by performing a corresponding assistant action. As a non-limiting example, the fulfillment engine 1036 can receive an intent and/or parameter(s) for an assistant action that causes a thermostat in the living room to set room temperature at 72 F. In this example, the fulfillment engine 1036 can fulfill the intent by generating and forwarding a control signal to the thermostat in the living room, where the control signal causes the thermostat to set the room temperature at 72 F. Optionally, when the NLU engine 1034 cannot resolve the intent(s) and/or cannot determine all parameter(s) for the intent(s), to fulfill an assistant action, the fulfillment engine 1036 can generate a default message or response, such as “Sorry, I don't understand. Please try again. In this case, the default response can be customized based on functions or a type of the voice assistant.

In some implementations, the voice assistant 103 can include, but does not necessarily need to, a text-to-speech (TTS) engine 1035. The TTS engine 1035 can convert a text to a synthesized speech (e.g., using a particular voice), for instance, when the text includes responsive content generated in response to a spoken utterance from a user. The synthesized speech, for instance, can be generated by using one or more trained speech synthesis neural network models to process the text. The synthesized speech can be audibly rendered via hardware speaker(s) of the client computing device 10 (e.g., a stand-alone speaker) or via another device (e.g., a cell phone).

In some implementations, the voice assistant 103 can be in communication with a cloud-based voice assistant (e.g., at the server computing device 12) via the one or more networks 13. The cloud-based automated assistant can have a plurality of cloud-based components (e.g., cloud-based signal processing engine 121, cloud-based ML model engine 123, etc.), the same as or similar to the plurality of components of the voice assistant 103, while possessing stronger processing capabilities. In some implementations, various components, such as any of 1034-1036, may be implemented in whole or in part on server computing device 12.

In some implementations, the voice assistant 103 can be large language model (LLM) -based, instead of or in addition to having the aforementioned components such as the ASR engine 1033, the NLU engine 1034, the TTS engine 1035, and/or the fulfillment engine 1036. For instance, the voice assistant 103 can include a trained LLM model that can generate content responsive to utterance content recognized based on processing of aforementioned ultrasound reflections that capture a mouth motion that delivers a silent utterance (e.g., using the fine-tuned transformer-based ML model 190). The trained LLM model may also determine and execute one or more API calls to perform an application action (e.g., change temperature setting for a smart thermostat controllable via a thermostat application) specified in utterance content recognized based on processing of the ultrasound reflections that capture a different mouth motion that delivers a different silent utterance.

In some implementations, the client computing device 10 can further include a rendering engine (not depicted), one or more additional applications in addition to the voice assistant 103, and/or a data storage 106. The one or more additional applications can include, for example, a social media application, a video player, a note-taking application, a shopping application, a messaging application, and/or any other appropriate applications (or services), installed at (or accessible via) the client computing device 10.

In various implementations, the rendering engine can be configured to provide content for audible and/or visual presentation to a user of the client computing device 10 using the one or more output devices. For example, the client computing device 10 can be equipped with a display or projector that enables content to be provided for visual presentation to the user via the client computing device 10. Additionally, or alternatively, the client computing device 10 can be equipped with one or more speakers 102B that enables content to be provided for audible presentation to the user via the client computing device 10.

The server computing device 12 can be, for example, a web server, one or more blade servers acting together to provide “cloud” infrastructure, or any other type of server as needed. In various implementations, the server computing device 12 can include cloud-based components the same as or similar to hardware and/or software components of the client computing device 1. For example, the server computing device 12 can include the cloud-based signal processing engine 121, the cloud-based ML model engine 123, a cloud-based ASR engine (not depicted), a cloud-based TTS engine (not depicted), a cloud-based prompt-generating engine (not depicted), and/or a cloud-based LLM engine (not depicted). In some implementations, the server computing device 12 (and/or the client computing device 10) can include a data storage 124.

The data storage 106 at the client computing device 10 (or a data storage 124 at the server computing device 12) can store various types of files and/or data. For instance, the data storage 106 or 124 can store application data of the voice assistant 103 (and/or other applications), user data (e.g., one or more user profiles) of a user of the client computing device 10, and/or other metadata. For instance, the data storage 106 or 124 can store training instance(s) to fine tune a pre-trained transformer-based ML model (which is pre-trained based on a large image dataset), to generate the fine-tuned transformer-based ML model 190.

In some implementations, the server computing device 12 (or the client computing device 10) can further include a training instance generating engine 125 to generate one or more training instances to fine tune the pre-trained transformer-based ML model. More detailed descriptions regarding generation of the one or more training instances can be found, for instance, hereinafter with reference to FIG. 1F.

It is noted that, in some implementations (e.g., where explicit voice interactions are desired), the aforementioned ASR engine 1033 (and/or the cloud-based ASR engine) can optionally process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, corresponding predicted measure(s) (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 103 and/or 123 can select one or more of the ASR hypotheses as corresponding recognized text (“transcript”) that corresponds to the spoken utterance(s) (e.g., selected based on the corresponding predicted measures). In some implementations, uttered content determined from ultrasonic signaling as described herein may be provided as an additional signal that can be used to disambiguate between and/or select from the various ASR hypotheticals. For example, if two or more hypotheticals have similar probabilities, e.g., because the user's environment is noisy, the uttered content determined from ultrasonic signaling as described herein may be used to select one hypothetical over the other.

FIG. 1B illustrates an example scenario where a transformer-based machine learning model is utilized in understanding an unvoiced utterance, in accordance with various implementations disclosed herein. As shown in FIG. 1B, a user R may be working in an open space and does not want to disturb others using a spoken utterance of “Press ‘play’” in order to view a video recording of a seminar. In this non-limiting example, the user R can provide an unvoiced utterance (“silent utterance”) by silently mouthing “press play”, which can be realized by a mouth motion (or a lip motion). The user R may need to be, for instance, within a predetermined distance (e.g., 20 cm, or 30 cm, etc.) from the client device.

In the above example, to perform mouth or lip reading to recognize the unvoiced utterance of “press play” (without or in addition to monitoring for spoken utterance(s) using the microphone 102A), the speaker 102B of a client device (e.g., a laptop as depicted) can emit an ultrasound signal Sₑ. In various implementations the ultrasound signal Sₑ may be a Tukey-tapered, linear chirp that linearly spans/varies a frequency from approximately 21 kHz to 22 kHz. In some implementations, the linear chirp may be repeated at a chirp repetition rate of approximately 20 Hz. The ultrasound signal Sₑ can be reflected by static (e.g., wall) or dynamic objects (e.g., a moving person, or a person that moves her mouth, etc.), so that reflections can be received by the microphone 102A.

In some implementations, the ultrasound signal Sₑ can be reflected by a mouth of the user R when the user performs a mouth motion of the mouth to deliver the unvoiced utterance (e.g., “press play”). Corresponding reflections Sᵣ of the ultrasound signal Sₑ can be multi-path reflections, reflected from different portions (e.g., left areas of upper or lower lip, middle areas of the upper or lower lip, right areas of the upper or lower lip, tongue, interior surface(s) of the mouth, etc.) of the mouth of the user. The reflections Sᵣ of the ultrasound signal Sₑ can be received using one or more microphones 102A, and be transformed into an ultrasound signal wave 131. The ultrasound signal wave 131 can be processed using the signal processing engine 121, to determine a waterfall image. The waterfall image can be linearly divided into a sequence of time-aligned waterfall image chunks 135.

The sequence of time-aligned waterfall image chunks 135 can be processed using a fine-tuned machine learning model 190A, to recognize utterance content 137 of the unvoiced utterance (e.g., “Okay, Assistant” or “Press play”, etc.). The fine-tuned machine learning model 190A can include a pre-trained linear projector 1911. Each of the sequence of time-aligned waterfall image chunks can be respectively processed using the pre-trained linear projector 1911 to generate a corresponding input embedding (e.g., a N-dimensional numeric vector, E1, E2, E3, E4, E5, . . . , or En). For instance, the pre-trained linear projector 1911 can be a single feed forward layer containing a embedding matrix (Eₘ) to be multiplied with a single vector that stores all pixels from a respective image chunk (e.g., a first image chunk) in the sequence of the time-aligned waterfall image chunks, to obtain a corresponding input embedding (e.g., E1). The single vector for each image chunk can be acquired by unrolling/flattening all pixels of a respective image chunk in a one-dimensional vector. It is noted that an input embedding that corresponds to a respective image chunk can have a reduced dimension than a corresponding single vector that includes all pixels of the respective image chunk.

In some implementations, the generated embeddings (e.g., E1, E2, E3, E4, E5, . . . , and En) and a positional embedding representing position information (and therefore a time order of mouth movements in the mouth motion) between the generated input embeddings can be processed using a pre-trained transformer encoder 1913, to generate an encoder output 133. It is noted that the pre-trained linear projector 1911 and the pre-trained transformer encoder 1913 can form a pre-trained portion 191 of the fine-tuned machine learning model 190A.

The encoder output 133 can be processed using a fully connected layer 1905 (e.g., “fine-tuned classifier”), to derive the utterance content 137 of the unvoiced utterance (e.g., “Okay, Assistant” or “Press play”). Based on the utterance content 137 of the unvoiced utterance (e.g., “Okay, Assistant” or “Press play”), the voice assistant 103, for instance, can be invoked or controlled (e.g., pursuant to the control signal or an instruction CS) to perform an assistant action (e.g., press a “play” button rendered at a graphical user interface of the client device).

FIG. 1C illustrates another example scenario where a transformer-based machine learning model is utilized in understanding an unvoiced utterance, in accordance with various implementations disclosed herein. As shown in FIG. 1B, a user R may be working in an open space and does not want to disturb others using a spoken utterance such as “set thermostat at home to 72”. In this working example, the user R can provide an unvoiced utterance by silently mouthing “set thermostat at home to 72”, which can be realized by a mouth motion (or a lip motion). In this case, to perform mouth or lip reading to recognize the unvoiced utterance of “set thermostat at home to 72”, the speaker 102B of a client device can once again emit an ultrasound signal Sₑ. The ultrasound signal Sₑ can once again be reflected by a mouth of the user where the user performs a mouth motion of the mouth to deliver the unvoiced utterance (e.g., “set thermostat at home to 72”). Corresponding reflections S′ᵣ of the ultrasound signal Sₑ can be multi-path reflections, reflected from different portions (e.g., left areas of upper or lower lip, middle areas of the upper or lower lip, right areas of the upper or lower lip, tongue, etc.) of the mouth of the user. The reflections S′ᵣ of the ultrasound signal Sₑ can be received using one or more microphones 102A, and be transformed into an ultrasound signal wave 131′. The ultrasound signal wave 131′ can once again be processed using the signal processing engine 121, to determine a waterfall image. The waterfall image can be linearly divided into a sequence of time-aligned waterfall image chunks 135′.

The sequence of time-aligned waterfall image chunks 135′ can be processed using the transformer-based machine learning model 190B to recognize utterance content of the unvoiced utterance (e.g., “press play”), or to generate responsive content or API calls that are responsive to the recognized utterance content. The machine learning model 190B can include the pre-trained linear projector/mapper 1911, where each of the sequence of time-aligned waterfall image chunks can be respectively processed using the pre-trained linear projector 1911, to generate a corresponding input embedding (e.g., a N-dimensional numeric vector, E1′, E2′, E3′, E4′, E5′, . . . , or En′) in a latent space.

In some implementations, the generated embeddings (e.g., E1′, E2′, E3′, E4′, E5′, . . . , and En′) and a positional embedding P′ representing position information between the generated input embedding can be processed using the pre-trained transformer encoder 1913, to generate an encoder output 133′ (e.g., a sequence of image embeddings representing image features extracted from the image sequence 135′). The encoder output 133′ can be processed using a text decoder 1907 to transcribe the encoder output 133′ (e.g., the sequence of image embeddings) into utterance/word content of the unvoiced utterance (e.g., “set thermostat at home to 72”). Optionally, a prompt can be generated based on the utterance content and be processed as input, using a pre-trained LLM, to generate an API call of the thermostat application for the thermostat used by the user R at home and an instruction to execute the API call, which causes the thermostat at home to be set to 72.

In some implementations, alternatively, the encoder output 133′ can be processed using a transformer decoder (e.g., a fine-tuned LLM) to generate content responsive to the utterance content of the unvoiced utterance (e.g., “set thermostat at home to 72”), or to generate and execute API calls responsive to the utterance content of the unvoiced utterance (e.g., “set thermostat at home to 72”).

FIG. 1D illustrates pre-training of a transformer-based machine learning model portion (e.g., 191) using a large set of images, in accordance with various implementations disclosed herein. As shown in FIG. 1D, the transformer-based machine learning model portion 191 can be pre-trained using an image database 1061 which stores the large set of images (e.g., a total number of N images). Each image in the large set can have a corresponding label (“ground truth label”) that identifies an object or event in the image. An image i (where i can be any integer from 1 to N) can be divided into a plurality of image patches 108, and the plurality of image patches 108 can be linearly arranged and processed using the linear projector 1911 to generate corresponding input embeddings (e.g., e1, e2, e3, e4, e5, . . . , en). The corresponding input embeddings (e.g., e1, e2, e3, e4, e5, . . . , en) and a position embedding p indicating a position of each image patch in image i can be processed using the transformer encoder 1913, and an output of the transformer encoder 1913 can be processed using a fully connected layer 1917, to generate a classification output (e.g., a plurality of probabilities each indicating a likelihood that the image i corresponds to one of a predefined set of image labels (e.g., cat, dog, duck, etc.)). Based on comparing the classification output and the ground truth label (e.g., cat) for image i, parameters of the transformer encoder 1913 and the fully connected layer 1917 can be adjusted. This way, the transformer-based machine learning model portion 191 is pre-trained.

FIG. 1E illustrates fine-tuning of the transformer-based machine learning model in FIG. 1D using additional images each generated based on reflections of an ultrasound signal that capture a mouth motion associated with an unvoiced utterance, in accordance with various implementations disclosed herein. As shown in FIG. 1E, a plurality of additional images can be generated to fine tune the fully connected layer 1917 in FIG. 1D (or another classifier) to obtain the fine-tuned classifier 1905. The additional images can include, as a non-limiting example, a first additional image 1061, a second additional image 1062, and a third additional image 1063 (and/or other images). The first additional image 1061 can be generated based on ultrasound reflections of an ultrasound signal from a mouth that performs a first mouth motion to deliver a first silent utterance such as “Okay Assistant”. The second additional image 1062 can be generated based on ultrasound reflections of an ultrasound signal from a mouth that performs a second mouth motion to deliver a second silent utterance such as “Press Play”. The third additional image 1063 can be generated based on ultrasound reflections of an ultrasound signal from a mouth that performs no mouth motion.

In this non-limiting example, the first additional image 1061 can be labeled with a first label of “Okay Assistant”. The second additional image 1062 can be labeled with a second label of “Press Play”. The third additional image 1063 can be labeled with a third label of “null”. Given any of the labeled additional images such as additional image j (where j is greater than or equal to 1 and less than or equal to 3), the additional image j can be linearly divided (e.g., using a linear image dividing engine 126, which can be included in the server computing device 12 or client computing device 10) into a plurality of time-aligned image chunks 107. The plurality of time-aligned image chunks 107 can be processed using the pre-trained linear projector 1911 to generate a plurality of embeddings (e.g., I1, I2, I3, I4, I5, . . . , In). The plurality of embeddings (e.g., I1, I2, I3, I4, I5, . . . , In) and a position embedding Pj indicating a position of each image chunk in the image j can be processed using the transformer encoder 1913 (pre-trained), to generate a corresponding encoder output. The encoder output can be processed using the pre-trained fully connected layer 1917 (or other classifier) to generate a plurality of probabilities. Each probability may indicate a likelihood that utterance content of the unvoiced utterance which is indicated by image j matches a respective label from a plurality of pre-defined labels (e.g., label 1071, label 1072, label 1073, etc.). Based on the plurality of probabilities, the pre-trained fully connected layer 1917 (or other pre-trained classifier) can be fine-tuned, e.g., by having its parameters adjusted while weights of the pre-trained encoder 1913 can remain the same/frozen.

FIG. 1F illustrates an example scenario where a waterfall image is generated based on reflections of an ultrasound signal, in accordance with various implementations disclosed herein. As shown in FIG. 1F, a client device 10 (e.g., a cellphone) can include a speaker 141 that emits an ultrasound signal 143. The ultrasound signal 143 can be, for instance, a Tukey-tapered, linear chirp that linearly spans/varies a frequency from approximately 21 kHz to 22 kHz. The linear chirp can be repeated at a chirp repetition rate of approximately 20 Hz. The ultrasound signal 143 can be reflected at different areas of a mouth over a certain time interval during which a particular mouth motion is performed by the user. The particular mouth motion can be performed to deliver a particular silent utterance (or a voiced utterance). The reflections over the certain time interval can be collected by a microphone 142 of the client device 10 in an ultrasound waveform 144.

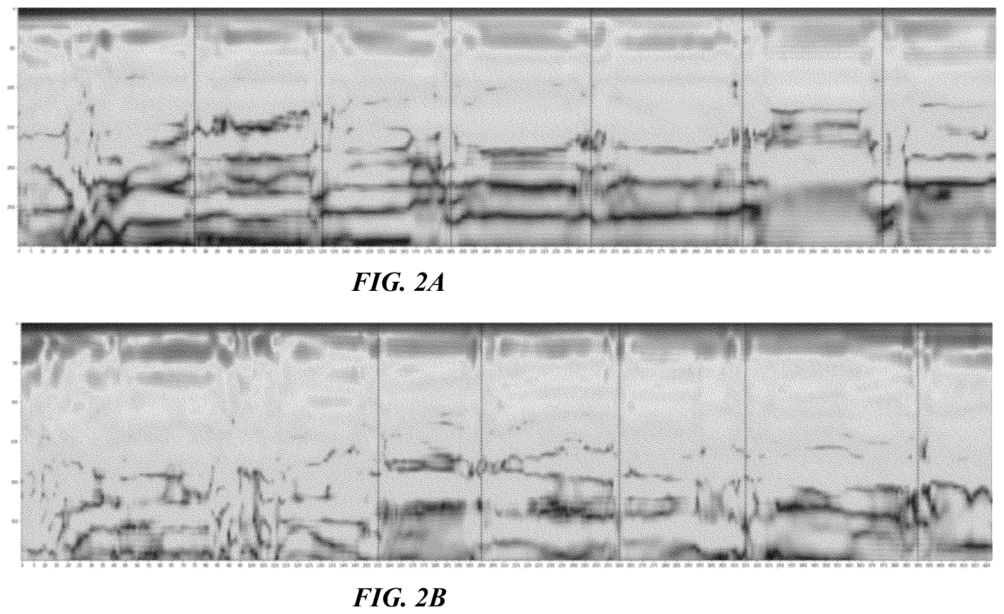

The ultrasound waveform 144 which corresponds to the reflections 144 (of the ultrasound signal 143) that capture the particular mouth motion can be processed using a pulse compressor 103A, to generate a pulse compressed signal 145. As a non-limiting example, the pulse compressed signal 145 can be processed using a signal dividing engine 103B (as part of a waterfall reconstruction engine 1031) that divides the pulse compressed signal 145 into a set of signal portions 146 (S1, S2, S3, . . . ) each corresponding to a predefined time duration (e.g., t1). The set of signal portions 146 can be processed using a rasterization engine 103C (as another part of the waterfall reconstruction engine 1031) which can re-arrange the orientation of a waveform (e.g., clock-wise rotation the waveform by 90 degrees) for each signal portion (e.g., S1, S2, or S3) in the set of signal portions 146 and convert rotated waveform into a raster image (e.g., M1, M2, or M3) composed of individual pixels. The raster images (M1, M2, M3) can be respectively re-sized and combined to generate a waterfall image 147 (specific example can be found as depicted in FIG. 2A or 2B) that captures mouth motion information associated with the particular mouth motion.

Further referring to FIG. 1F, the training instance generating engine 125 can be applied to generate a training instance 148 based on the generated waterfall image 147. For instance, the training instance 148 can include the generated waterfall image 147 (or a sequence of time-aligned waterfall image chunks divided therefrom) can a training instance input, and can include utterance content (e.g., “okay assistant”, “press play”, etc.) of the particular silent utterance as a ground truth label. The training instance 148 can be stored in the data storage 124 or 106, and can be applied to fine-tune the transformer-based machine learning model, such as 190A.

FIG. 2A depicts an example of a waterfall image showing waterfall features for an unvoiced utterance, in accordance with various aspects of the present disclosure. FIG. 2B depicts an example of a waterfall image showing waterfall features for another unvoiced utterance, in accordance with various aspects of the present disclosure.

As shown in FIG. 2A, a waterfall image can be generated based on performing waterfall reconstruction on reflections (or pulse compression thereof) of an ultrasound signal that are reflected from a mouth of a user when a mouth motion of the mouth is performed by the user to deliver a unvoiced utterance, such as “Okay, Assistant”. As shown in FIG. 2B, a different waterfall image can be generated based on performing waterfall reconstruction on reflections (or pulse compression thereof) of an ultrasound signal that are reflected from a mouth of a user when a mouth motion of the mouth is performed by the user to deliver an additional unvoiced utterance, such as “Press play”.

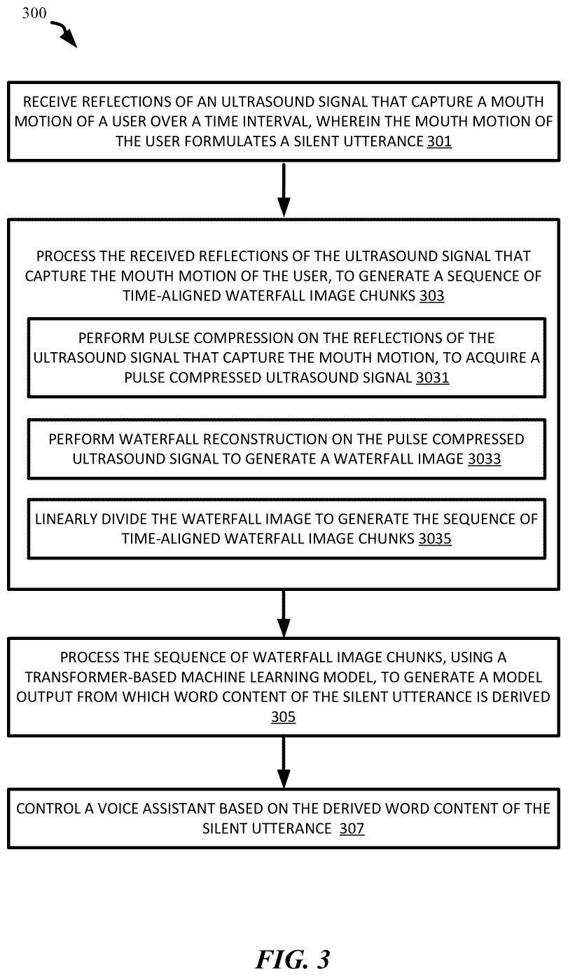

Turning now to FIG. 3, a flowchart illustrating an example method of recognizing an unvoiced utterance using a trained transformer-based machine learning model is provided, in accordance with various aspects of the present disclosure. For convenience, the operations of the method 300 are described with reference to a system that performs the operations. This system of the method 300 includes one or more processors, memory, and/or other component(s) of computing device(s) (e.g., server computing device 12 of FIG. 1, one or more servers, and/or other computing devices). Moreover, while operations of the method 300 are shown in a particular order, this is not meant to be limiting. One or more operations may be reordered, omitted, and/or added.

In various implementations, at block 301, the system can receive, via a client device, reflections, of an ultrasound signal, that capture a silent utterance. In some implementations, the silent utterance is delivered via a mouth motion of a user of the client device. In some implementations, the client device includes a speaker to emit the ultrasound signal and a microphone to receive the reflections. In some implementations, the ultrasound signal includes a Tukey-tapered, linear chirp (e.g., a coded signal) that linearly spans/varies a frequency from approximately 21 kHz to 22 kHz, where the linear chirp is repeated at a chirp repetition rate of approximately 20 Hz. While FIG. 3 refers to “silent” utterances, it should be clear that techniques described herein are equally applicable to spoken utterances, e.g., in noisy environments.

In various implementations, at block 303, the system can process the received reflections (of the ultrasound signal) that capture the mouth motion, to generate a sequence of time-aligned waterfall image chunks. In some implementations, the system processes the received reflections of the ultrasound signal reflecting the silent utterance, by: performing pulse compression on the reflections of the ultrasound signal that capture the mouth motion, to acquire a pulse compressed ultrasound signal (block 3031); performing waterfall reconstruction on the pulse compressed ultrasound signal to generate a waterfall image (block 3033); and linearly dividing the waterfall image to generate the sequence of time-aligned waterfall image chunks (block 3035).

In various implementations, at block 305, the system can process the sequence of waterfall image chunks, using a transformer-based machine learning model, to generate a model output that recognizes word content of the silent utterance.

In some implementations, the transformer-based ML model includes a linear mapper/projector (e.g., 1911 in FIG. 1B) that linearly projects the sequence of time-aligned waterfall image chunks into an embedding space. The linear mapper of the transformer-based ML model can linearly project the sequence of time-aligned waterfall image chunks into the embedding space by: generating a sequence of input embeddings for the sequence of time-aligned waterfall image chunks in the embedding space. Each input embedding from the sequence of image embeddings can correspond to a respective image chunk from the sequence of time-aligned waterfall image chunks.

In some implementations, the transformer-based ML model includes a transformer encoder (e.g., 1913 in FIG. 1B) to encode the sequence of input embeddings and a position embedding that identifies a position of each image chunk in the sequence of time-aligned waterfall image chunks. In some implementations, the transformer-based ML model includes a classifier (e.g., 1905 in FIG. 1B) to classify the silent utterance based on an encoder output (e.g., 133 in FIG. 1B) of the transformer encoder that correspond to the sequence of input embeddings. In some implementations, the transformer-based machine learning model includes a text decoder to transcribe the image embeddings into the word content (may also be referred to as “utterance content”) of the silent utterance. In some implementations, a frequency of the ultrasound signal (emitted by the speaker of the client device) can be modified based on a transcription rate of the image embeddings into the word content of the silent utterance. The ultrasound signal, for instance, can have a frequency range of approximately 21-23 kHz.

In some implementations, the transformer-based ML model can be trained based on a large set of training data and/or be fine-tuned using a plurality of training instances (e.g., the training instance 148 in FIG. 1F). The plurality of training instances can include, for instance, a first set of training instances. Each training instance from the first set can include a waterfall image constructed based on ultrasound reflections, which are from a user that uses a mouth motion to deliver a first silent utterance (e.g., “Okay, Assistant”), for an ultrasound signal emitted by a speaker of a computing device, as training instance input. The same training instance can include training instance output derived from the first silent utterance (e.g., “Okay, Assistant”). For instance, the same training instance can include a ground truth label of the first silent utterance (e.g., “Okay, Assistant”) as the training instance output.

Additionally or alternatively, the plurality of training instances can include, for instance, a second set of training instances. Each training instance from the second set can include a waterfall image constructed based on ultrasound reflections, which are from a user that uses a mouth motion to deliver a second silent utterance (e.g., “Press play”), for an ultrasound signal emitted by a speaker of a computing device, as training instance input. The same training instance can include training instance output derived from the second silent utterance (e.g., “Press play”). For instance, the same training instance can include a ground truth label of the second silent utterance (e.g., “Press play”) as the training instance output.

Optionally, different training instances from the first set (or other set, if there is any) can respectively include a waterfall image constructed based on ultrasound reflections received from different users. For instance, a first training instance from the first set can include a waterfall image constructed based on ultrasound reflections received from a first user, and a second training instance from the first set can include a waterfall image constructed based on ultrasound reflections received from a second user (different from the first user).

Optionally, different training instances from the first set (or other set, if there is any) can respectively include a waterfall image constructed based on ultrasound reflections of an ultrasound signal emitted by a distinct client device. For instance, a first training instance from the first set can include a waterfall image constructed based on ultrasound reflections of a first ultrasound signal emitted by a first computing device (e.g., a laptop), and a second training instance from the first set can include a waterfall image constructed based on ultrasound reflections of a second ultrasound signal emitted by a second computing device (e.g., another laptop, or another type of computing device different from the first computing device, such as a cellphone, etc.). The first ultrasound signal can be the same as or different from the second ultrasound signal.

Additionally or alternatively, the plurality of training instances can include, for instance, a third set of training instances. Each training instance from the third set can include a waterfall image constructed based on ultrasound reflections, which are from a user when the user has no mouth motion (and as a result, no utterance, be it silent utterance or spoken utterance), for an ultrasound signal emitted by a speaker of a computing device, as training instance input. The same training instance can include a ground truth label of “null” (or “no utterance”, etc.) as the training instance output.

In various implementations, at block 307, the system can control a voice assistant based on the recognized word content of the silent utterance. In some implementations, the system controls the voice assistant by: invoking the voice assistant based on the recognized word content of the silent utterance including a hotword that invokes the voice assistant. The hotword can be configured by a developer (or service provider) of the voice assistant, and for instance, can be “Okay, Assistant” or “Assistant”, etc.

In some implementations, the system controls the voice assistant by: controlling a voice assistant based on the recognized word content of the silent utterance including one or more words that identify the assistant action.

In some implementations, the voice assistant can be invoked or controlled using an audible utterance (“voiced utterance”), in addition to being invoked/controlled using unvoiced utterance(s). For instance, the voice assistant can be invoked in response to a spoken speech of “Hey Assistant”, based on a speech recognition of the utterance content of the spoken speech indicates that the utterance content of the spoken speech includes hotword(s) (e.g., “Hey Assistant”) that triggers operation of the voice assistant. In some implementations, the voice assistant can be invoked or controlled based on silent voice interfaces of a camera that captures images showing a mouth motion of a user that delivers a silent utterance.

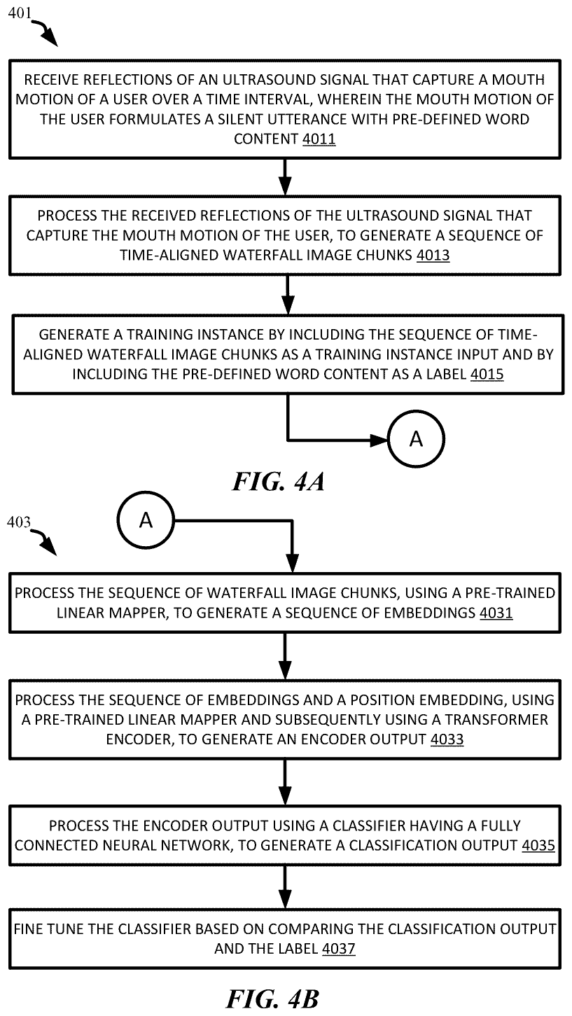

Turning now to FIG. 4A, a flowchart illustrating an example method 401 of generating a training instance to train a transformer-based machine learning model is provided, in accordance with various aspects of the present disclosure. This system of the method 401 includes one or more processors, memory, and/or other component(s) of computing device(s) (e.g., client computing device 10 of FIG. 1, one or more servers, and/or other computing devices). Moreover, while operations of the method 401 are shown in a particular order, this is not meant to be limiting. One or more operations may be reordered, omitted, and/or added.

At block 4011, the system receives reflections of an ultrasound signal that captures a mouth motion of a user over a time interval, wherein the mouth motion of the user formulates a silent utterance with pre-defined word content.

At block 4013, the system processes the received reflections of the ultrasound signal that capture the mouth motion of the user, to generate a sequence of time-aligned waterfall image chunks.

At block 4015, the system generates a training instance by including the sequence of time-aligned waterfall image chunks as a training instance input and by including the pre-defined word content as a label. The method 401 can continue to point “A”, or the process from block 4011˜4015 can be repeated to generate additional training instance(s) each based on a different mouth motion.

FIG. 4B depicts a flowchart illustrating an example method 403 for fine-tuning a transformer-based machine learning model, in accordance with various aspects of the present disclosure. This system of the method 403 includes one or more processors, memory, and/or other component(s) of computing device(s) (e.g., client computing device 10 of FIG. 1, one or more servers, and/or other computing devices). Moreover, while operations of the method 403 are shown in a particular order, this is not meant to be limiting. One or more operations may be reordered, omitted, and/or added.

At block 4031, the system processes the sequence of waterfall image chunks, using a pre-trained linear mapper, to generate a sequence of input embeddings.

At block 4033, the system processes the sequence of input embeddings and a position embedding, using a pre-trained linear mapper and subsequently using a transformer encoder, to generate an encoder output.

At block 4035, the system processes the encoder output using a classifier that includes a fully connected neural network, to generate a classification output.

At block 4037, the system fine tunes the classifier based on comparing the classification output and the label (at block 4015).

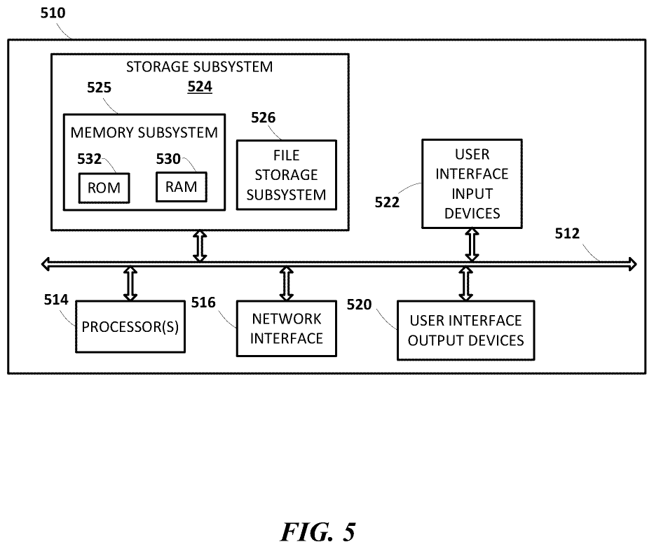

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

In various implementations, a method implemented using one or more processors is provided. The method includes: receiving a waveform that represents reflections of an ultrasound signal that capture a mouth motion of a user over a time interval, wherein the mouth motion of the user formulates a silent utterance; processing the received waveform to generate a sequence of time-aligned waterfall image chunks; processing the sequence of time-aligned waterfall image chunks, using a transformer-based machine learning model, to generate a model output from which word content of the silent utterance is derived; and causing a voice assistant to be controlled based on the derived word content of the silent utterance.

In some implementations, processing the received reflections of the ultrasound signal that capture the mouth motion of the user, to generate the sequence of time-aligned waterfall image chunks can include: performing pulse compression on the reflections of the ultrasound signal that capture a silent utterance, to acquire a pulse compressed waveform; performing waterfall reconstruction on the pulse compressed waveform to generate a waterfall image that encodes the mouth motion of the user; and linearly dividing the waterfall image to generate the sequence of time-aligned waterfall image chunks.

In some implementations, the reflections are received via a client device, and the client device includes at least a speaker to emit the ultrasound signal and at least a microphone to receive the reflections.

In some implementations, causing the voice assistant to be controlled based on the recognized word content of the silent utterance can include: causing the voice assistant to be invoked in response to the derived word content of the silent utterance including a hotword that invokes the voice assistant.

In some implementations, causing the voice assistant to be controlled based on the recognized word content of the silent utterance can include: causing an assistant action to be performed via the voice assistant in response to the recognized word content of the silent utterance including one or more words identifying the assistant action.

In some implementations, the transformer-based machine learning model includes a classifier to classify the silent utterance.

In some implementations, the transformer-based machine learning model includes a linear mapper. The linear mapper can linearly projects the sequence of time-aligned waterfall image chunks into an embedding space by generating a sequence of image embeddings for the sequence of time-aligned waterfall image chunks in the embedding space. In some implementations, the transformer-based machine learning model includes a text decoder to transcribe the sequence of image embeddings into the word content of the silent utterance.

In some implementations, the method further includes: modifying a frequency of the ultrasound signal based on a transcription rate of the word content of the silent utterance.

In some implementations, the method further includes: modifying a repetition rate of the ultrasound signal based on a transcription rate of the word content of the silent utterance.

In some implementations, the ultrasound signal is a Tuckey-tapered, linear chirp having a repetition rate of approximately 20 Hz.

In some implementations, the method further includes: modifying a repetition rate of the ultrasound signal based on a motion rate of the mouth motion of the user.

In some implementations, the ultrasound signal has a frequency range of approximately 21-22 kHz.

In some implementations, the voice assistant is controllable using an audible utterance.

In various implementations, a system is provided. The system can include a speaker, a microphone, one or more processors, and memory storing instructions that, when executed, cause the one or more processors to perform one or more operations. The speaker can transmit an ultrasound signal. The microphone can receive reflections of the ultrasound signal. The reflections can capture a mouth motion of a user over a time interval, and wherein the mouth motion formulates a silent utterance.

In some implementations, the one or more processors can process the received reflections of the ultrasound signal that capture the mouth motion of the user, to generate a sequence of time-aligned waterfall image chunks; process the sequence of time-aligned waterfall image chunks, using a transformer-based machine learning model, to generate a model output from which word content of the silent utterance is derived; and cause a voice assistant to be invoked or perform an assistant action based on the derived word content of the silent utterance.

In some implementations, the transformer-based machine learning model includes a linear mapper that linearly projects the sequence of time-aligned waterfall image chunks into an embedding space by generating a sequence of image embeddings for the sequence of time-aligned waterfall image chunks in the embedding space.

In some implementations, the transformer-based machine learning model includes a text decoder to transcribe the sequence of image embeddings into the word content of the silent utterance.

In some implementations, a frequency or a repetition rate of the ultrasound signal is modified based on a transcription rate of the word content of the silent utterance.

In some implementations, the ultrasound signal is a Tuckey-tapered, linear chirp having a repetition rate of approximately 20 Hz and having a frequency range of approximately 21-22 kHz.

In various implementations, a method implemented using one or more processors is provided. The method includes: receiving, via one or more microphone of a client device, reflections of an ultrasound signal that capture a mouth motion of a user over a time interval, where the mouth motion of the user formulates a silent utterance; transmitting a waveform of the received reflections of the ultrasound signal that capture the mouth motion of the user to a server device, where the waveform of the received reflections is processed to generate a sequence of time-aligned waterfall image chunks, and where the sequence of time-aligned waterfall image chunks is processed using a transformer-based machine learning model, to generate a model output from which word content of the silent utterance is derived; and causing a voice assistant to be invoked or to perform an assistant action based on the derived word content of the silent utterance.

What is claimed is:

1. A method implemented using one or more processors, the method comprising:
receiving a waveform that represents reflections of an ultrasound signal that capture a mouth motion of a user over a time interval, wherein the mouth motion of the user formulates a silent utterance;
processing the received waveform to generate a sequence of time-aligned waterfall image chunks;
processing the sequence of time-aligned waterfall image chunks, using a transformer-based machine learning model, to generate a model output from which word content of the silent utterance is derived; and
causing a voice assistant to be controlled based on the derived word content of the silent utterance.

2. The method of claim 1, wherein processing the received reflections of the ultrasound signal that capture the mouth motion of the user, to generate the sequence of time-aligned waterfall image chunks comprises:
performing pulse compression on the reflections of the ultrasound signal that capture a silent utterance, to acquire a pulse compressed waveform,
performing waterfall reconstruction on the pulse compressed waveform to generate a waterfall image that encodes the mouth motion of the user, and
linearly dividing the waterfall image to generate the sequence of time-aligned waterfall image chunks.

3. The method of claim 1, wherein the reflections are received via a client device, and wherein the client device includes a speaker to emit the ultrasound signal and a microphone to receive the reflections.

4. The method of claim 1, wherein causing the voice assistant to be controlled based on the recognized word content of the silent utterance comprises:
causing the voice assistant to be invoked in response to the derived word content of the silent utterance including a hotword that invokes the voice assistant.

5. The method of claim 1, wherein causing the voice assistant to be controlled based on the recognized word content of the silent utterance comprises:
causing an assistant action to be performed via the voice assistant in response to the recognized word content of the silent utterance including one or more words identifying the assistant action.

6. The method of claim 1, wherein the transformer-based machine learning model includes a classifier to classify the silent utterance.

7. The method of claim 1, wherein the transformer-based machine learning model includes a linear mapper that linearly projects the sequence of time-aligned waterfall image chunks into an embedding space by generating a sequence of image embeddings for the sequence of time-aligned waterfall image chunks in the embedding space.

8. The method of claim 7, wherein the transformer-based machine learning model includes a text decoder to transcribe the sequence of image embeddings into the word content of the silent utterance.

9. The method of claim 8, further comprising: modifying a frequency of the ultrasound signal based on a transcription rate of the word content of the silent utterance.

10. The method of claim 8, further comprising: modifying a repetition rate of the ultrasound signal based on a transcription rate of the word content of the silent utterance.

11. The method of claim 9, wherein the ultrasound signal is a Tuckey-tapered, linear chirp having a repetition rate of approximately 20 Hz.

12. The method of claim 1, further comprising: modifying a repetition rate of the ultrasound signal based on a motion rate of the mouth motion of the user.

13. The method of claim 1, wherein the ultrasound signal has a frequency range of approximately 21-22 kHz.

14. The method of claim 1, wherein the voice assistant is controllable using an audible utterance.

15. A system comprising:
a speaker that transmits an ultrasound signal;
a microphone that receives reflections of the ultrasound signal, wherein the reflections capture a mouth motion of a user over a time interval, and
wherein the mouth motion formulates a silent utterance;
one or more processors; and
memory storing instructions that, when executed, cause the one or more processors to:
process the received reflections of the ultrasound signal that capture the mouth motion of the user, to generate a sequence of time-aligned waterfall image chunks;
process the sequence of time-aligned waterfall image chunks, using a transformer-based machine learning model, to generate a model output from which word content of the silent utterance is derived; and
cause a voice assistant to be invoked or perform an assistant action based on the derived word content of the silent utterance.

16. The system of claim 15, wherein the transformer-based machine learning model includes a linear mapper that linearly projects the sequence of time-aligned waterfall image chunks into an embedding space by generating a sequence of image embeddings for the sequence of time-aligned waterfall image chunks in the embedding space.

17. The system of claim 16, wherein the transformer-based machine learning model includes a text decoder to transcribe the sequence of image embeddings into the word content of the silent utterance.

18. The system of claim 17, wherein a frequency or a repetition rate of the ultrasound signal is modified based on a transcription rate of the word content of the silent utterance.

19. The system of claim 15, wherein the ultrasound signal is a Tuckey-tapered, linear chirp having a repetition rate of approximately 20 Hz and having a frequency range of approximately 21-22 kHz.

20. A method implemented using one or more processors, the method comprising:
receiving, via one or more microphone of a client device, reflections of an ultrasound signal that capture a mouth motion of a user over a time interval, wherein the mouth motion of the user formulates a silent utterance;
transmitting a waveform of the received reflections of the ultrasound signal that capture the mouth motion of the user to a server device,
wherein the waveform of the received reflections is processed to generate a sequence of time-aligned waterfall image chunks, and
wherein the sequence of time-aligned waterfall image chunks is processed using a transformer-based machine learning model, to generate a model output from which word content of the silent utterance is derived; and
causing a voice assistant to be invoked or to perform an assistant action based on the derived word content of the silent utterance.
